(19) United States
(12) Patent Application Publication
(10) Pub. No.: US 2025/0289055 A1
(43) Pub. Date: Sep. 18, 2025

(54) METAL PARTICLES AND PREPARATION METHOD THEREFOR

(71) Applicant: SUZHOU AMART ENTERPRISE MANAGEMENT CO. LTD., Suzhou (CN)

(72) Inventor: Qiang GONG, Suzhou (CN)

(21) Appl. No.: 18/861,198

(22) PCT Filed: Mar. 13, 2023
(86) PCT No.: PCT/CN2023/081077

§ 371 Date: Oct. 28, 2024

(30) Foreign Application Priority Data
May 25, 2022 (CN) 202210578685.2

(51) Int. Cl. B22F 9/24; B22F 1/0655; B22F 1/07; B22F 1/10; B22F 1/148

(52) U.S. Cl. CPC B22F 9/24; B22F 1/0655; B22F 1/07; B22F 1/10; B22F 1/148

(57) ABSTRACT

Provided in the present disclosure are metal particles and a preparation method therefor, the preparation method for the metal particles comprising the following step: in the presence of a first dispersing agent and a second dispersing agent, subjecting an oxidizing agent containing a metal source and a reducing agent to a redox reaction, so as to obtain the metal particles, wherein the first dispersing agent comprises a first organic solvent having a low molecular weight and at least one nanoparticle, and the second dispersing agent comprises a second organic solvent having a high molecular weight. The metal particles of the present disclosure have the advantages of a high shrinkage ratio, a high specific surface area, high sphericity, etc.; and the preparation method is simple and efficient.

### FIELD OF THE INVENTION

The present disclosure belongs to the field of metal materials, and in particular relates to metal particles and a preparation method therefor.

### BACKGROUND OF THE INVENTION

Noble metals mainly refer to eight metal elements such as gold, silver, and platinum group metals (ruthenium, rhodium, palladium, osmium, iridium, and platinum). Most of these metals have beautiful colors, have strong chemical stability, and do not easily chemically react with other chemicals under general conditions. Noble metal powder has important uses in the preparation of solar cell paste-electronic components, conductive adhesives, and the like, and particularly silver powder as a conductive filler is currently the most widely used noble metal powder.

The properties of metal powder, including not only a particle size, but also a morphology and an internal structure, play a decisive role in the properties of a metal paste. Internally porous metal powder is a new type of material developed in recent years, and because of its fine particles and a large number of internal voids, porous metal powder has a large specific surface area, a small specific gravity, and excellent permeability. Hollow metal powder has become a new hot spot due to their wide applications in catalysis, electrochemistry, drug delivery, and the like.

At present, a main preparation method for metal particles includes: a biological template method, a liquid phase reduction method, a chemical deposition method, a pyrolysis method, etc., but the template method has a complex process and a high cost; the liquid phase reduction method is expensive, and a liquid phase microwave method is harsh in reaction, so it is difficult to achieve large-scale industrial production. For example, CN101905330A discloses a preparation method of hollow silver by Streptococcus thermophilus, and CN101912970A discloses a preparation method of spherical porous silver powder by a spray method, but there are problems such as harsh reaction conditions, more chips and uneven particle size distribution.

Therefore, there is still a need for a preparation method that can prepare metal particles having a high cavity ratio, a large specific surface area, and good sphericity, and has a simple process and a low cost.

### SUMMARY OF THE INVENTION

An object of the present disclosure is to overcome the above disadvantages in the prior art and provide a preparation method for metal particles. The metal particles have the advantages of a high shrinkage ratio, a high specific surface area, high sphericity, etc., and the preparation method is simple and efficient.

In order to achieve the above object, in one aspect, the present disclosure provides a preparation method for metal particles, including: subjecting an oxidizing agent containing a metal source and a reducing agent to a redox reaction in the presence of a first dispersing agent and a second dispersing agent to obtain the metal particles, wherein the first dispersing agent includes a first organic solvent having a low molecular weight and at least one nanoparticle; and the second dispersing agent includes a second organic solvent having a high molecular weight.

In the preparation method provided by the present disclosure, the presence of the first dispersing agent and the second dispersing agent plays a critical role in the preparation of metal particles having the advantages of a high shrinkage ratio, a high specific surface area, high sphericity, etc., because the organic solvent having a low molecular weight in the first dispersing agent can effectively coat the nanoparticles to form a coating mass; however, macromolecules of the organic solvent having a high molecular weight in the second dispersing agent can be well embedded with the coating mass to form a homogeneous system, so that nanoparticles in a first stage of the redox reaction are less prone to agglomeration. More specifically, metal particles generated at an initial stage of the redox reaction can be prevented from adhering to form a metal film structure due to the action of the organic solvent of the first dispersing agent at the initial stage of the redox reaction; metal particles in the first stage are formed after the reaction for a few seconds or minutes, and cavities are formed inside the formed metal particles; subsequently, the newly formed metal particles in the first stage are polymerized in the environment of the second dispersing agent to form metal particles in which larger cavities are formed, which is because in the two-stage reaction, organic macromolecules having a high molecular weight of the second dispersing agent form larger cavities between the metal particles during polymerization of the metal particles.

As described above, as long as the oxidizing agent containing the metal source and the reducing agent of the present disclosure are subjected to the redox reaction in the presence of the first dispersing agent and the second dispersing agent, and an initial system of the reaction and an order of addition of the oxidizing agent and the reducing agent and the like are not particularly limited. For example, the oxidizing agent can be added in advance to a system of the first dispersing agent and the second dispersing agent, and then the reducing agent is added, thereby carrying out the redox reaction; the reducing agent can be added in advance to the system of the first dispersing agent and the second dispersing agent, and then the oxidizing agent is added, thereby carrying out the redox reaction; or the oxidizing agent and the reducing agent can be simultaneously added to the system of the first dispersing agent and the second dispersing agent, thereby carrying out the redox reaction. That is, the oxidizing agent and the reducing agent of the present disclosure may be mixed with the system of the first dispersing agent and the second dispersing agent separately or simultaneously, without particular limitations. Additionally, the oxidizing agent and reducing agent may be provided in a supplementary feeding manner.

The first dispersing agent and the second dispersing agent of the present disclosure each include an organic solvent, but the difference is that the organic solvent in the first dispersing agent and the organic solvent in the second dispersing agent have different molecular weights, i.e., the molecular weight of the organic solvent (i.e., the second organic solvent) included in the second dispersing agent is higher than the molecular weight of the organic solvent (i.e., the first organic solvent) included in the first dispersing agent. In one embodiment of the present disclosure, the low molecular weight and the high molecular weight may also be divided at a specific molecular weight, e.g., 1200 Da. Thus, in this embodiment, the first organic solvent may be an organic solvent having a molecular weight of less than or equal to 1200 Da (e.g., less than or equal to 1000 Da, or less than or equal to 800 Da), and the second organic solvent may be an organic solvent having a molecular weight of greater than 1200 Da (e.g., greater than 1500 Da).

The kinds of the first organic solvent and the second organic solvent are not particularly limited except for the difference in molecular weight. For example, in one embodiment of the present disclosure, the first organic solvent and the second organic solvent are each independently selected from at least one of organic acid (including but not limited to fatty acid), gum arabic, esters, ethers, ether esters, ketones, amines, alcohols, pyridines, and pyrrolidone organic solvents. That is, the first organic solvent and the second organic solvent may be the same or different, and may include one or more of the organic solvents described above.

More specifically, in one embodiment of the present disclosure, the first organic solvent may be selected from at least one of fatty acid and a salt thereof, alkylsulfuric acid and a salt thereof, alkylbenzene sulfonic acid and a salt thereof, linear alkylbenzene sulfonic acid and a salt thereof, maleic acid and a salt thereof, 1-vinylpyrrolidone, N-vinylpyrrolidone, methylpyrrolidone, triethanol tridecyl ether sulfate, octylamine, ethanol, polyethylene glycol, triethanol alkyl sulfate, glycerol, alkyl ether sulfate, sorbitol, sorbitan, polysorbate (Tween), sorbitan fatty acid ester (Span), lecithin, polysorbate dialkyldimethylammonium chloride, alkylpyridinium chloride, polyoxyethylene alkyl ether (AE), polyoxyethylene alkylphenyl ether (APE), alkylcarboxybetaine, and sulfobetaine; and the second organic solvent is selected from at least one of gum arabic, a formaldehyde condensate of naphthalene sulfonate, polyacrylate, a copolymer salt of a vinyl compound and a carboxylic monomer, carboxymethylcellulose, polyvinyl alcohol, polyethylene glycol, polypartial alkyl acrylate and/or polyalkylenepolyamine, polyethyleneimine and/or an aminoalkyl methacrylate copolymer, polyvinylpyrrolidone, polystyrenesulfonic acid, polyacrylic acid, polyoxyethylene alkyl ether, and polyoxyethylene alkylphenyl ether, but is not limited thereto.

Additionally, the first dispersing agent of the present disclosure further includes at least one nanoparticle, wherein the nanoparticle may be selected from at least one of organic nanoclusters, a non-metallic oxide, an elemental metal, a metal oxide, and a metal inorganic salt, preferably the nanoparticle may have a size of 0.1-90 nm (e.g., 0.1 nm, 0.2 nm, 0.5 nm, 1 nm, 2 nm, 5 nm, 10 nm, 20 nm, 30 nm, 40 nm, 50 nm, 70 nm, or 90 nm, 1-50 nm, 0.1-40 nm, or the like).

More specifically, in one embodiment of the present disclosure, the organic nanoclusters may be selected from at least one of cellulose and organic carbohydrates; the non-metallic oxide may be selected from at least one of oxides of silicon, carbon and nitrogen (i.e., silicon oxide, carbon oxide, and nitrogen oxide); the metal may be selected from at least one of gold, silver, platinum, palladium, cobalt, copper, nickel, and zinc; the metal oxide may be selected from at least one of oxides of gold, silver, platinum, palladium, cobalt, copper, nickel, and zinc; and the metal inorganic salt may be selected from metal sulfate and/or nitrate (e.g., sodium sulfate, ammonium sulfate, potassium sulfate, copper sulfate, iron sulfate, sodium nitrate, potassium nitrate, iron nitrate or copper nitrate, etc.), but is not limited thereto.

For the oxidizing agent containing the metal source of the present disclosure, the metal source (typically metal ions) will be reduced to a metal in a redox process, the oxidizing agent containing the metal source of the present disclosure may thus be any compound containing metal ions, wherein the metal includes, but is not limited to, at least one of gold, silver, platinum, palladium, cobalt, copper, nickel, and zinc, or the metal may in particular be a noble metal, such as at least one of gold, silver, and platinum group metals (ruthenium, rhodium, palladium, osmium, iridium, and platinum). For example, in one embodiment of the present disclosure, the oxidizing agent containing the metal source may be selected from at least one of an inorganic metal salt, an organic metal salt, and a metal complex.

More specifically, in one embodiment of the present disclosure, the inorganic salt may be, for example, at least one of carbonate, bicarbonate, phosphate, phosphite, hydrogen phosphate, nitrate, nitrite, chlorate, bromate, iodate, sulfate, sulfite, bisulfate, and the like; the organic salt may be, for example, acetate, adipate, aspartate, benzoate, benzenesulfonate, camsylate, citrate, cyclohexylamine sulfonate, edisylate, formate, fumarate, glucoheptonate, gluconate, glucuronate, hexafluorophosphate, 2-isethionate, lactate, malate, maleate, malonate, methanesulfonate, methylsulfate, naphthoate, 2-naphthalenesulfonate, nicotinate, nitrate, oxalate, hexadecanoate, pyroglutamate, glucarate, stearate, salicylate, tannate, tartrate, tosylate, and trifluoroacetate, and the like; and the metal complex may be, for example, an ammonium salt, a metal-ammonia solution, or the like.

As for the reducing agent of the present disclosure, the kind of the reducing agent is not particularly limited in the preparation method of the present disclosure as long as its reducing ability is sufficient to reduce the metal source in the oxidizing agent to the metal. For example, in one embodiment of the present disclosure, the reducing agent is selected from hydrazines (hydrazine, hydrazine monohydrate, phenylhydrazine, hydrazine sulfate, etc.), amines (dimethylaminoethanol, triethylamine, octylamine, dimethylaminoborane, etc.), organic acids (citric acid, ascorbic acid, tartaric acid, malic acid, malonic acid, or salts thereof, formic acid, formaldehyde, etc.), alcohols (methanol, ethanol, isopropanol, ethylene glycol, diethylene glycol, triethylene glycol, tetraethylene glycol, benzotriazole, etc.), aldehydes (formaldehyde, acetaldehyde, and propionaldehyde); hydrides (sodium borohydride, lithium borohydride, lithium triethylborohydride, lithium aluminum hydride, diisobutylaluminum hydride, tributyltin hydride, lithium tri-sec-butylborohydride, potassium tri-sec-butylborohydride, zinc borohydride, and sodium acetoxyborohydride), salts of transition metals (iron sulfate and tin sulfate), pyrrolidones (polyvinylpyrrolidone, 1-vinylpyrrolidone, N-vinylpyrrolidone, and methylpyrrolidone) and hydroxylamines (hydroxylamine sulfate and hydroxylamine nitrate) reducing agents.

As for the usage amounts of the first dispersing agent and the second dispersing agent, the oxidizing agent, and the reducing agent in the preparation method of the present disclosure, in one embodiment of the present disclosure, a molar amount of the reducing agent may be 0.1-9 times, preferably 0.5-7 times, more preferably 1-5 times (e.g., 1, 2, 3, 4, or 5 times, or the like, preferably, the redox reaction is just completed) compared with a molar amount of metal (i.e., the metal source) in the oxidizing agent. When the amount of the reducing agent used is too low, unreduced metals may remain; and when the amount of the reducing agent used is excessively high, the reaction may be excessively fast, resulting in an increase in the number of coagulated particles, and an increase in a deviation of a final particle size. In another embodiment of the present disclosure, the weight of the first dispersing agent may be 0.1-40 wt % (e.g., 0.1 wt %, 0.5 wt %, 1 wt %, 5 wt %, 10 wt %, 20 wt %, or 40 wt %, or the like), the weight of the second dispersing agent may be 1-60 wt % (e.g., 1 wt %, 5 wt %, 10 wt %, 20 wt %, 40 wt %, or 60 wt %, or the like), and the weight of the nanoparticle may be 0.0001-1.0 wt % (e.g., 0.0001 wt %, 0.001 wt %, 0.01 wt %, 0.1 wt %, or 1 wt %, or the like), preferably 0.005-0.01 wt % compared with the weight of the metal (i.e., the metal source) in the oxidizing agent.

In addition, as for the reaction conditions of the preparation method of the present disclosure, the reaction may be carried out at normal temperature or under appropriate heating. For example, in one embodiment of the present disclosure, the reaction may be carried out at a temperature of 1-90° C., preferably 20-80° C., more preferably 25-50° C. (e.g., 25° C., 30° C., 35° C., 40° C., 45° C., or 50° C., or the like). In order to achieve a homogeneous reaction, the preparation method of the present disclosure may also be carried out under stirring, for example, a stirring speed may range from 5 rpm to 1000 rpm.

In particular, the preparation method of the present disclosure may further include adding a flocculant after or before the redox reaction, however, it is also possible to eliminate the need for further addition of the flocculant due to the selection of different dispersing agents. The flocculant can change the charge potential on the particles and the surfaces of the particles combined with other particles, and then nano-metal particles free of a mother liquor can be obtained through separation. In one embodiment of the present disclosure, the flocculant may be selected from a lipid compound, a carboxylic acid compound or an inorganic salt. More specifically, in one embodiment of the present disclosure, the lipid compound includes a lipid precursor and a derivative thereof, such as a saturated fatty acid and a salt thereof or an unsaturated fatty acid and a salt thereof, preferably, the saturated fatty acid is selected from at least one of caprylic acid, capric acid, lauric acid, myristic acid, palmitic acid, stearic acid and arachidic acid; the unsaturated fatty acid is selected from at least one of oleic acid, linoleic acid, sorbic acid, linolenic acid, and arachidonic acid; the carboxylic acid compound is at least one of a compound having a carbon-carbon double bond, a dicarboxyl compound and a dihydroxy compound, and the inorganic salt is selected from at least one of a sulfate, a nitrate and an ammonium salt, but is not limited thereto. In another embodiment of the present disclosure, the flocculant may be added in an amount of 0.001%-20% (e.g., 0.001%, 0.01%, 0.1%, 1%, 10%, 15%, or 20%, etc.) of the weight of the metal particles.

In another aspect, the present disclosure also provides metal particles prepared by the above method.

As described above, under the action of the first dispersing agent and the second dispersing agent, the metal particles of the present disclosure obtained by the redox reaction have cavities including not only closed cavities formed inside metal particles during the reaction in a first stage, but also cavities formed between metal particles in a second stage, and the cavities between the metal particles may be formed in the surfaces of the metal particles. Therefore, the metal particles provided by the present disclosure have the advantages of a high shrinkage ratio, a high specific surface area, high sphericity, etc., and are suitable for being applied to the technical fields of printed circuit boards, solar cells, etc. In one embodiment of the present disclosure, the metal particles may have a cavity ratio of not less than 2.97%.

It should be noted that the endpoints of the ranges and any values disclosed herein are not limited to the precise range or value, and these ranges or values should be understood to encompass values close to these ranges or values. For numerical ranges, endpoint values of each range, endpoint values of each range and individual point values, and individual point values may be combined with each other to obtain one or more new numerical ranges, and these numerical ranges should be considered as specifically disclosed herein.

Before describing the present disclosure in detail, it should be understood that the terms used herein are for the purpose of describing particular embodiments only, and are not intended to limit the scope of the present disclosure, which is defined only by the appended claims. For a more complete understanding of the present disclosure described herein, the following terms are used, and their definitions are shown below. Unless otherwise defined, all technical and scientific terms used herein have the same meaning as understood by those of ordinary skill in the art to which the present disclosure belongs.

### BRIEF DESCRIPTION OF DRAWINGS

The accompanying drawings are intended to provide a further understanding of the present disclosure and constitute a part of this specification, and together with the detailed description below serve to explain the present disclosure, but are not to be construed as limiting the present disclosure. In the accompanying drawings:

FIG. 1 shows silver metal particles prepared by Example 1 of the present disclosure;

FIG. 2 shows a microscopic observation result of a single silver metal particle prepared by Example 2 of the present disclosure, and the surface of the single silver metal particle has a multi-porous structure;

FIG. 3 shows a microscopic observation result of a single silver metal particle prepared by Example 2 of the present disclosure, but shows one particle not completely polymerized to the surface of the silver particle;

FIG. 4 shows a microscopic observation result of a single silver metal particle prepared by Example 3 of the present disclosure;

FIG. 5 shows a cut sectional view of a single particle of the silver metal particles prepared by Example 1 of the present disclosure at a magnification of 80K;

FIG. 6 shows a cut sectional view of a single particle of silver metal particles prepared by Example 2 of the present disclosure at a magnification of 50K;

FIG. 7 shows a cut sectional view of another single particle of the silver metal particles prepared by Example 2 of the present disclosure at a magnification of 50K;

FIG. 8 shows a cut sectional view of a single particle of silver metal particles prepared by Example 3 of the present disclosure at a magnification of 50K;

FIG. 9 shows a cut sectional view of a single particle of silver metal particles prepared by Example 4 of the present disclosure at a magnification of 50K;

FIG. 10 shows a cut sectional view of a single particle of silver metal particles prepared by Comparative example 1 of the present disclosure at a magnification of 50K; and

FIG. 11 is an enlarged partial view of FIG. 9.

### DETAILED DESCRIPTION OF THE INVENTION

Specific embodiments of the present disclosure are described in detail below. It should be understood that the specific embodiments described herein are merely illustrative and explanatory of the present disclosure, and are not intended to limit the present disclosure.

In the following examples, the metal particles were cut by the FIB-SEM technology, the metal particles were cut by using a focused ion beam of gallium particles, a single metal particle was cut so that a cross section of the metal particle was exposed, and the cross section of the particle was observed by a scanning electron microscope (SEM).

### EXAMPLES

### Example 1

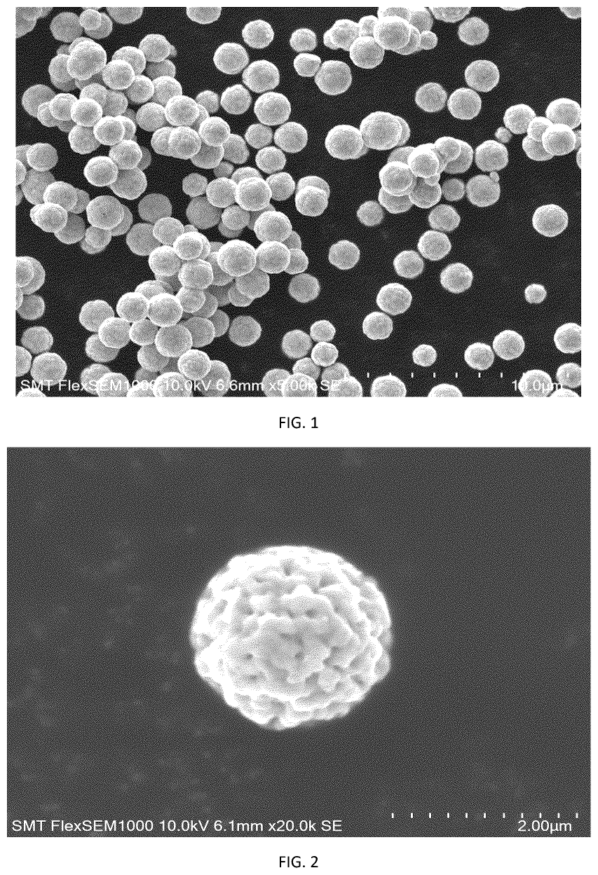

10 ml of sorbitol and 35 μg of 40-90 nm cellulose were mixed to obtain a first dispersing agent, and carboxymethyl cellulose was dissolved in 35 ml of water to prepare a solution with a mass concentration of 6.5% as a second dispersing agent; and the first dispersing agent and the second dispersing agent prepared above were uniformly mixed and stirred to obtain a dispersing agent system, and the solution was maintained at a constant temperature of 35° C.; and
in addition, 17 g of silver nitrate was added to a beaker filled with a certain amount of water to be uniformly stirred, then the resulting silver nitrate solution was added to the dispersing agent system, followed by addition of a solution having a mass concentration of 20% and containing 20 g of hydroxylamine sulfate under stirring, and after a reaction, oleic acid was added to obtain silver metal particles having a pore structure. The microscopic observation results are shown in FIG. 1.

### Example 2

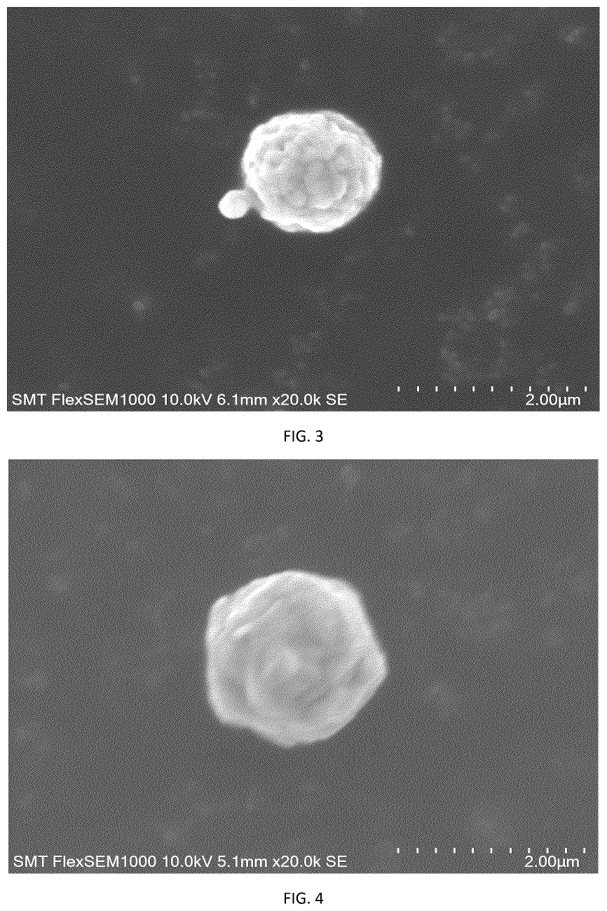

15 mL of maleic acid and 20 μg of 20-50 nm nano-silver oxide were mixed to obtain a first dispersing agent, and 3.5 g of gum arabic was dissolved in 50 mL of water to prepare a solution as a second dispersing agent; and the first dispersing agent and the second dispersing agent were uniformly mixed and stirred to obtain a dispersing agent system, and the solution was maintained at a constant temperature of 35° C.; and
a solution having a mass concentration of 25% and containing 20 g of ascorbic acid was prepared, the ascorbic acid solution was added to the dispersing agent system prepared above, in addition, 17 g of silver nitrate was added to 50 mL of an aqueous solution to be uniformly stirred, then the silver nitrate solution was added to the above solution under stirring for a reaction, and lauric acid was added after the reaction to obtain silver metal particles having a pore structure. The microscopic results are shown in FIGS. 2 and 3, where silver metal particles shown in FIG. 2 have a particle size of 2.2 μm; and silver metal particles shown in FIG. 3 have a particle size of 1.5 μm, but a case where one particle is not completely polymerized to the surfaces of the silver particles is shown.

### Example 3

3 g of Tween and 15 μg of 10-20 nm nano silver were mixed in water to obtain a first dispersing agent, and PVP was dissolved in 35 ml of water to prepare a solution with a mass concentration of 6.5% as a second dispersing agent; and the first dispersing agent and the second dispersing agent prepared above were uniformly mixed and stirred to obtain a dispersing agent system, and the solution was maintained at a constant temperature of 25° C.; and
in addition, 15 g of VC was added to a beaker filled with a certain amount of water to be uniformly stirred, then the resulting VC solution was added to the dispersing agent system, followed by rapid addition of a solution having a mass concentration of 20% and containing 10 g of silver nitrate under stirring, and after a reaction, oleylamine was added to obtain silver metal particles having a pore structure. The microscopic results are shown in FIG. 4.

### Example 4

5 g of sodium alkylbenzene sulfonate was dissolved in water to be mixed with 10 μg of 10-90 nm nanosilica to obtain a first dispersing agent, and 3.5 g of polyvinylpyrrolidone was dissolved in 35 ml of water to prepare a solution as a second dispersing agent; and the first dispersing agent and the second dispersing agent prepared above were uniformly mixed and stirred to obtain a dispersing agent system, and the solution was maintained at a constant temperature of 30° C.; and
subsequently, a solution having a mass concentration of 30% and containing 17 g of silver nitrate and a solution having a mass concentration of 28% and containing 5 g of hydrazine hydrate were simultaneously added to the dispersing agent system under stirring of the dispersing agent system, and after a reaction, sodium stearate was added to obtain silver metal particles having a pore structure.

### Comparative Example 1

15 μg of 10-20 nm nano-silver was mixed with PVP to prepare a solution with a mass concentration of 9% as a dispersing agent; and the solution was maintained at a constant temperature of 25° C.; and
in addition, 25 g of VC was added to a beaker filled with a certain amount of water to be uniformly stirred, then the resulting VC solution was added to a dispersing agent system, followed by rapid addition of a solution having a mass concentration of 25% and containing 15 g of silver nitrate under stirring, and after a reaction, linoleic acid was added to obtain silver metal particles.

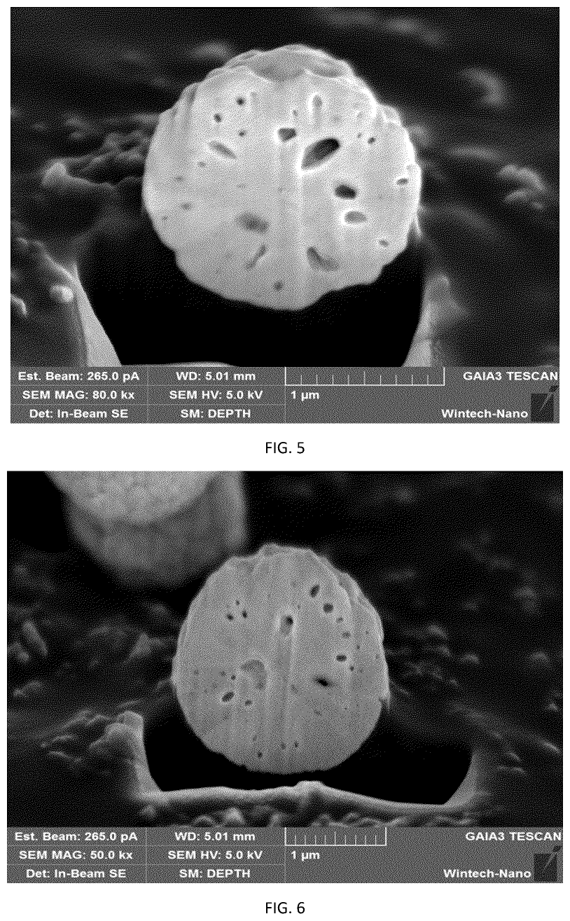

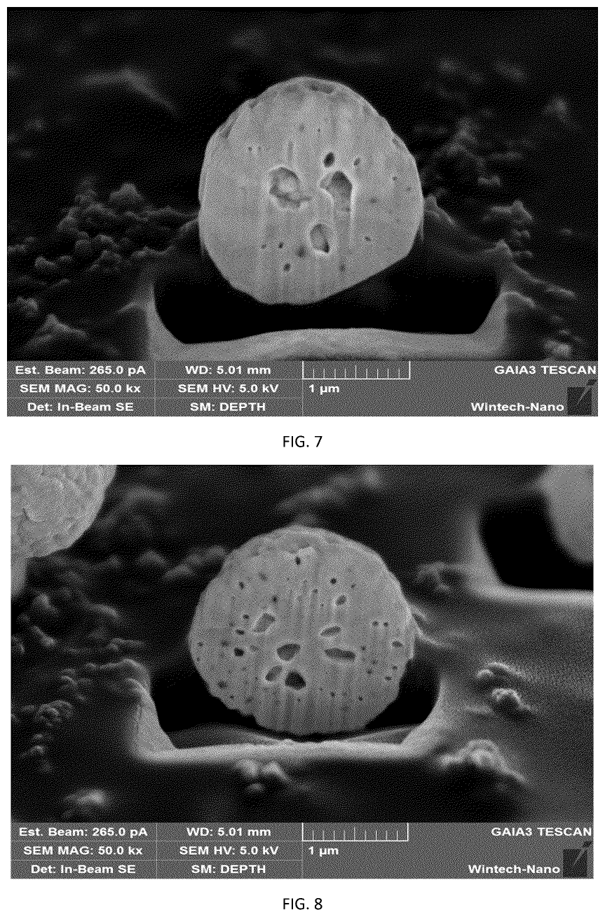

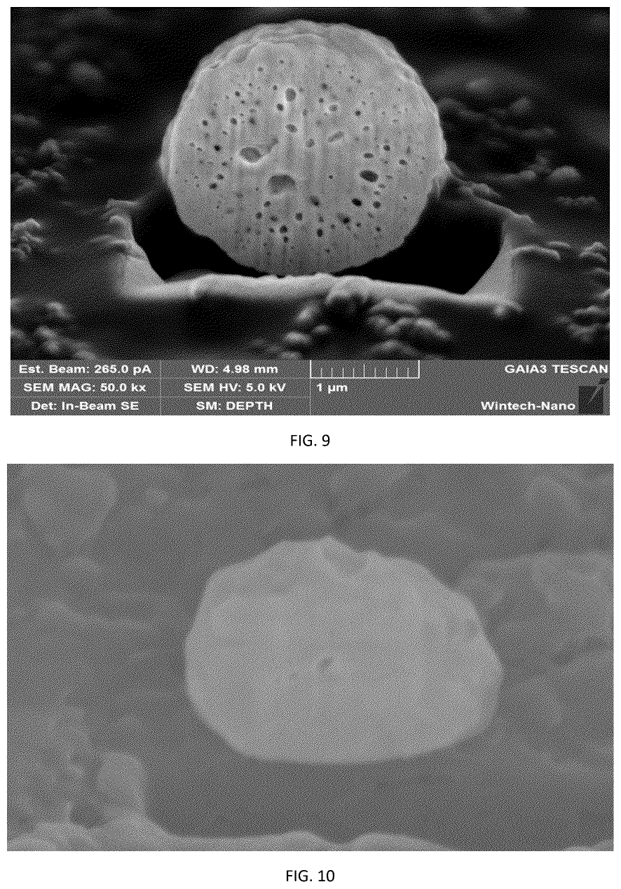

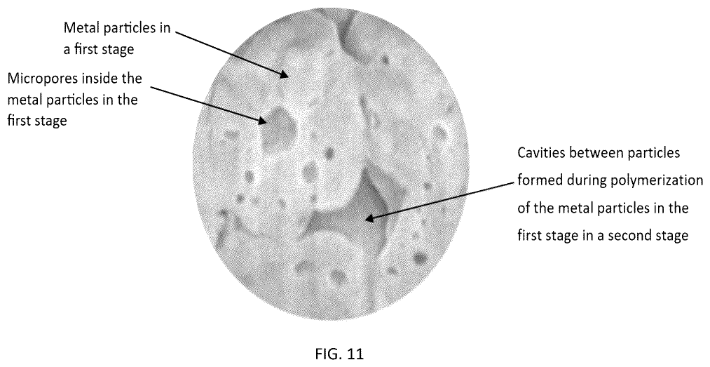

The metal particles in the above Examples 1-4 and Comparative example 1 were cut, and as described above, the metal particles were cut by the FIB-SEM technology, the metal particles were cut by using a focused ion beam of gallium particles, a single metal particle was cut so that a cross section of the metal particle was exposed, and the cross section of the particle was observed by a scanning electron microscope (SEM). A schematic cross-sectional view of the metal particles obtained in Example 1 after cutting is shown in FIG. 5; schematic cross-sectional views of the metal particles obtained in Example 2 after cutting are shown in FIGS. 6 and 7; schematic cross-sectional views of the metal particles obtained in Examples 3 and 4 is shown in FIGS. 8 and 9; and a schematic cross-sectional view of the metal particles obtained in Comparative example 1 after cutting is shown in FIG. 10.

A particle size of the silver metal particles, a cross-sectional area of the silver metal particles and a cavity area in FIGS. 5-10 at different contrasts were calculated by identifying different contrasts of the pictures by using orthographic projection under SEM observation, and the results are shown in Table 1 below. Wherein the measurement result is calculated by the average value of three measurements, and Cavity ratio=Cavity area/Cross-sectional area of silver metal particles.

TABLE 1

| Drawing | Particle | Cross-sectional area | Cavity area | Cavity |
|---|---|---|---|---|
| No. | diameter (μm) | of particles (μm²) | (μm²) | ratio |
| FIG. 5 | 1.83 | 2.63 | 0.23 | 8.64% |
| FIG. 6 | 2.33 | 4.26 | 0.13 | 2.97% |
| FIG. 7 | 2.32 | 4.23 | 0.32 | 7.67% |
| FIG. 8 | 2.20 | 3.80 | 0.42 | 11.16% |
| FIG. 9 | 2.70 | 5.72 | 0.34 | 5.93% |
| FIG. 10 | 2.25 | 3.97 | 0.01 | 0.25% |

As can be seen from FIGS. 5-10 and the results of Table 1, the silver metal particles obtained by the method of Comparative example 1 have a low cavity ratio, reaching only 0.25%, and in contrast, the silver metal particles obtained by the exemplary method of the present disclosure (Examples 1-4) have a better specific surface area, a high shrinkage ratio, high sphericity, and a cavity ratio of at least 2.97 or above, and even reaching 11.16%.

In addition, FIG. 11 is an enlarged partial view of FIG. 9, wherein cavities of the metal particles of the present disclosure are clearly shown, and the cavities include two types: cavities inside the newly formed metal particles in the first stage, and larger cavities between the metal particles formed during the polymerization of the metal particles in the reaction of the second stage.

The preferred embodiments of the present disclosure are described in detail above, however, the present disclosure is not limited to the specific details of the above embodiments, and many simple variations can be made to the technical solution of the present disclosure within the scope of the technical idea of the present disclosure, and these simple variations all fall within the protection scope of the present disclosure.

In addition, it should be noted that the specific technical features described in the above specific embodiments can be combined in any suitable manner without contradiction, and in order to avoid unnecessary repetition, various possible combinations will not be described separately in the present disclosure.

In addition, any combination of the various embodiments of the present disclosure can be made as long as they do not depart from the idea of the present disclosure, and they should also be regarded as the contents disclosed in the present disclosure.

1. A method for preparing metal particles, comprising subjecting an oxidizing agent containing a metal source and a reducing agent to a redox reaction in the presence of a first dispersing agent and a second dispersing agent to obtain the metal particles, wherein
the first dispersing agent comprises a first organic solvent having a low molecular weight and at least one nanoparticle; and
the second dispersing agent comprises a second organic solvent having a high molecular weight.

2. The method according to claim 1, wherein the first organic solvent is an organic solvent having a molecular weight of less than or equal to 1200 Da, the second organic solvent is an organic solvent having a molecular weight of greater than 1200 Da, and the first organic solvent and the second organic solvent are each independently selected from at least one of organic acid, gum arabic, esters, ethers, ether esters, ketones, amines, alcohols, pyridines, and pyrrolidone organic solvents.

3. The method according to claim 2, wherein the first organic solvent is selected from at least one of fatty acid and a salt thereof, alkylsulfuric acid and a salt thereof, alkylbenzene sulfonic acid and a salt thereof, linear alkylbenzene sulfonic acid and a salt thereof, maleic acid and a salt thereof, 1-vinylpyrrolidone, N-vinylpyrrolidone, methylpyrrolidone, triethanol tridecyl ether sulfate, octylamine, ethanol, polyethylene glycol, triethanol alkyl sulfate, glycerol, alkyl ether sulfate, sorbitol, sorbitan, polysorbate (Tween), sorbitan fatty acid ester (Span), lecithin, polysorbate dialkyldimethylammonium chloride, alkylpyridinium chloride, polyoxyethylene alkyl ether (AE), polyoxyethylene alkylphenyl ether (APE), alkylcarboxybetaine, and sulfobetaine.

4. The method according to claim 2, wherein the second organic solvent is selected from at least one of gum arabic, a formaldehyde condensate of naphthalene sulfonate, polyacrylate, a copolymer salt of a vinyl compound and a carboxylic monomer, carboxymethylcellulose, polyvinyl alcohol, polyethylene glycol, polypartial alkyl acrylate and/or polyalkylenepolyamine, polyethyleneimine and/or an aminoalkyl methacrylate copolymer, polyvinylpyrrolidone, polystyrenesulfonic acid, polyacrylic acid, polyoxyethylene alkyl ether, and polyoxyethylene alkylphenyl ether.

5. The method according to claim 1, wherein the nanoparticle is selected from at least one of organic nanoclusters, a non-metallic oxide, an elemental metal, a metal oxide, or a metal inorganic salt, and preferably the nanoparticle has a size of 0.1-90 nm.

6. The method according to claim 5, wherein the organic nanoclusters are selected from at least one of cellulose and organic carbohydrates; the non-metallic oxide is selected from at least one of oxides of silicon, carbon, and nitrogen; the metal is selected from at least one of gold, silver, platinum, palladium, cobalt, copper, nickel, and zinc; the metal oxide is selected from at least one of oxides of gold, silver, platinum, palladium, cobalt, copper, nickel, and zinc; and the metal inorganic salt is selected from metal sulfate or nitrate.

7. The method according to claim 1, wherein the oxidizing agent containing the metal source is selected from at least one of an inorganic metal salt, an organic metal salt, and a metal complex.

8. The method according to claim 7, wherein the metal is at least one of gold, silver, platinum, palladium, cobalt, copper, nickel, and zinc.

9. The method according to claim 1, wherein the reducing agent is selected from at least one of hydrazines, amines, organic acids and salts thereof, alcohols, aldehydes, hydrides, salts of transition metals, pyrrolidones, and hydroxylamine reducing agents.

10. The method according to claim 1, wherein a weight of the first dispersing agent is 0.1-40 wt %, a weight of the second dispersing agent is 1-60 wt %, and a weight of the nanoparticle is 0.0001-1.0 wt % compared with a weight of a metal in the oxidizing agent.

11. The method according to claim 1, further comprising adding a flocculant after or before the redox reaction.

12. The method according to claim 11, wherein the flocculant is selected from a lipid compound, a carboxylic acid compound or an inorganic salt.

13. The method according to claim 12, wherein the lipid compound is a saturated fatty acid and a salt thereof or an unsaturated fatty acid and a salt thereof, preferably the saturated fatty acid is selected from at least one of caprylic acid, capric acid, lauric acid, myristic acid, palmitic acid, stearic acid and arachidic acid; the unsaturated fatty acid is selected from at least one of oleic acid, linoleic acid, sorbic acid, linolenic acid, and arachidonic acid; the carboxylic acid compound is at least one of a compound having a carbon-carbon double bond, a dicarboxyl compound, and a dihydroxy compound; and the inorganic salt is selected from at least one of a sulfate, a nitrate, and an ammonium salt.

14. Metal particles, prepared by the method according to claim 1.

15. The metal particles according to claim 14, wherein the metal particles have a cavity ratio of not less than 2.97%.
